(19) United States
(12) Patent Application Publication
(10) Pub. No.: US 2015/0277416 A1
(43) Pub. Date: Oct. 1, 2015

(54) Method for Anomaly Detection in Discrete Manufacturing Processes

(71) Applicant: Mitsubishi Electric Research Laboratories, Inc., Cambridge, MA (US)

(72) Inventors: Daniel Nikolaev Nikovski, Brookline, MA (US); Michael J. Jones, Belmont, MA (US)

(73) Assignee: Mitsubishi Electric Research Laboratories, Inc., Cambridge, MA (US)

(21) Appl. No.: 14/230,141

(22) Filed: Mar. 31, 2014

(51) Int. Cl. G05B 19/05; G06N 99/00; G06N 7/00

(52) U.S. Cl. CPC G05B 19/056; G06N 7/005; G06N 99/005

(57) ABSTRACT

A method detects an anomaly in a discrete manufacturing process (DMP) by first acquiring signals from the DMP. Events are extracted from the signals as a sequence. Then, it is determined whether the sequence is inconsistent with a normal behavior as represented by a log-based ordering relationship table. If true, then an alarm is signaled.

### FIELD OF THE INVENTION

This invention relates generally to information technology for manufacturing, and more particularly to manufacturing execution systems, quality control systems, safety systems, and monitoring of discrete manufacturing processes.

### BACKGROUND OF THE INVENTION

Monitoring and controlling safety and quality are very important in manufacturing, where fast and powerful machines can execute complex sequences of operations at very high speeds. Deviations from an intended sequence of operations or timing can degrade quality, waste raw materials, cause down times and broken equipment, decrease output. Danger to workers is a major concern. For this reason, extreme care must be taken to carefully design manufacturing processes to minimize unexpected events, and also safeguards need to be designed into the production line, using, a variety of sensors and emergency switches.

The main types of manufacturing are process and discrete manufacturing. In process manufacturing, products are generally undifferentiated, for example oil, natural gas and salt, Discrete manufacturing produces distinct items, e.g., automobiles, furniture, toys, and airplanes.

One practical approach to increasing the safety and minimizing the loss of material and output is to detect when a production line is operating abnormally, and stop the line down if necessary in such cases. One way to implement this approach is to use a description of normal operation of the production line in terms of ranges of measurable variables, for example temperature, pressure, etc., defining an admissible operating region, and detecting operating points out of that region. This method is common in process manufacturing industries, for example oil refining, where there is usually a good understanding of permissible ranges for physical variables, and quality metrics for the product quality are often defined directly in terms of these variables.

However, the nature of the working process in discrete manufacturing is different from that in process manufacturing, and deviations from the normal working process can have very different characteristics. Discrete manufacturing includes a sequence of operations performed on work units, such as machining, soldering., assembling, etc. Anomalies can include incorrect execution of one or more of tasks, or an incorrect order of the tasks. Even in anomalous situations, often no physical variables, such as temperature or pressure are out of range, so direct monitoring of such variables cannot detect such anomalies reliably.

### SUMMARY OF THE INVENTION

The embodiments of the invention provide a method for detecting anomalies in discrete manufacturing processes (DMP), such as assembly lines. During training, data are acquired during normal operation of the DMP. The data are processed to form a stream of discrete events. An event relationship table for a normal operation is constructed from the events. Then, during online time processing, the table is used to detect anomalies in the operation of the DMP using data acquired in real-time.

The table has several advantages. First, the table can represent the correct workflow or normal operation of the DMP. Second, in contrast to conventional modeling formalisms, such as finite automata, the table represents compactly and accurately multiple sub-processes that are performed in parallel. Such sub-processes can either be independent, or coordinated. Third, the table represents the coordination between multiple sub-processes.

### BRIEF DESCRIPTION OF THE DRAWINGS

FIG. 1 is a schematic of a method for training and using an event relationship table for anomaly detection in discrete manufacturing processes according to embodiments of the invention;

FIG. 2 is the log-based ordering relation table of normal operation according to embodiments of the invention;

FIG. 3 is a flow diagram for determining if an event sequence is consistent with a relationship table of normal operation according to embodiments of the invention.

### DETAILED DESCRIPTION OF THE PREFERRED EMBODIMENTS

Anomaly Detection in Discrete Manufacturing Processes (DMP)

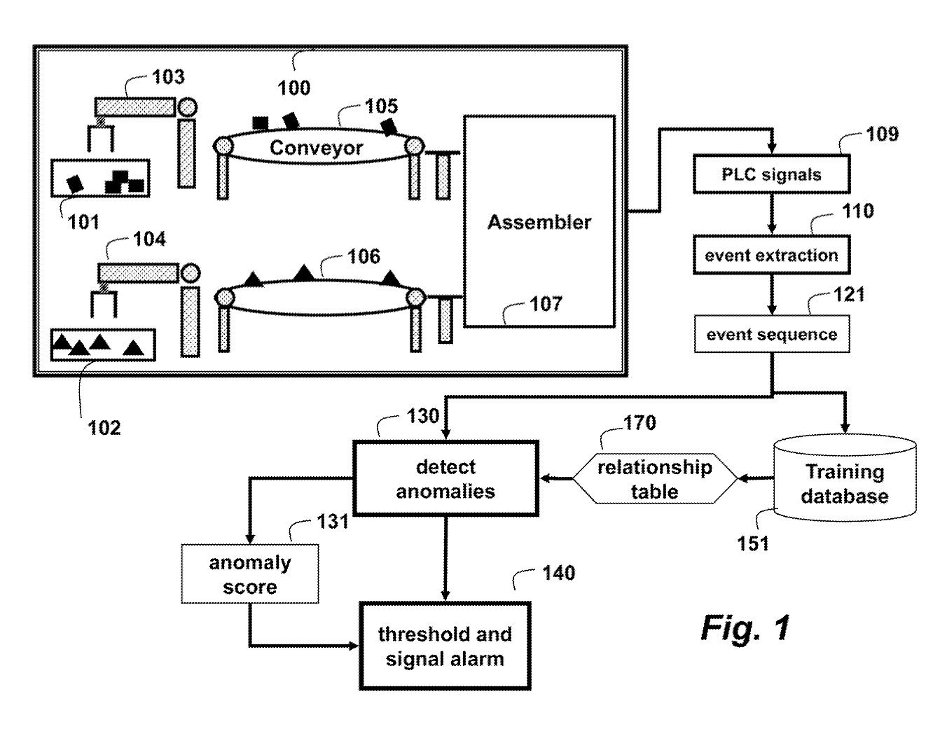

FIG. 1 shows a method for detecting anomalies in a discrete manufacturing process (DMP) 100 according to embodiments of our invention. The method includes off-line training and real-time processing. The training can be a one-time preprocessing task. Alternatively, the training is done as needed, e.g., to adapt to changing processing conditions. The method can be performed in a processing, device connected to memory and input/output interfaces by buses as known in the art.

The DMP includes bins 101-102, manufacturing robots 103-104, conveyors 105-106 and an assembler 106. During operation, the robots pick parts from the bin, and place the parts on the conveyer to be assembled.

Training

During training, signals 109 are acquired from programmable logic controllers (PLO) during normal operation of the DMP 100. The signals can also be acquired directly from various sensors, switches, and the like used by the DMP. The sensors can be connected to the various operational components of the DMP, e.g., the bins, robots, conveyer and assembler.

A sequence of events 121 is extracted 110 from the signals. The events are stored in a training database 151. The events are used to build a relationship table 170 of log-based ordering relations between all pairs of observed events of the normal operation of the DMP based on the table 170.

Detecting

The table is used to detect 130 anomalies in the signals 101 acquired in real-time by determining an anomaly score 131. if the score exceeds a predetermined threshold, then an alarm can be signaled 140.

Machine Learning

The invention uses machine learning to construct a relationship table of the event sequence from data measurements typically available from factory automation devices during normal operation. One major class of such devices includes programmable logic controllers (PLCs). The PLCs control the various devices and machines used during the DMP. Although PLCs can have digital and analog inputs and outputs, most applications primarily use digital signals, and more specifically, binary (logical) signals. For our method, we consider only digital binary signals that have two possible logical levels, 0 and 1. Examples for such signals are a binary output that turns a motor ON or OFF, or input that detects whether a switch is open or closed.

Event Sequence

The first step of the method is to acquire such data or signals from all PLC devices in the DMP. However, the actual level of the signals is not suitable for learning a model of the operating sequence. A lot more informative are changes in the levels. Therefore, the method extracts change events from the signals 109. When the level of a signal changes, an event and time are generated. For example, event (t, E, 0), where t is the time, E identifies the type of event, and 0 indicates a change from 1 to 0. A sequence of events is called an event trace. Multiple event traces can be recorded in the database 151 during the operation of the DMP 100.

For a single event trace, the sequence normally has a repetitive pattern due to the repetitive production of discrete components. Multiple repetitive patterns can be intermixed within the same event trace, for example obtained from multiple production sequences that are unsynchronized. More complicated patterns result from various combinations of synchronized and unsynchronized operations.

PLCs

In general, the synchronization of the production is implemented by programs in the PLCs. The programs can include ladder logic, functional blocks, or a. number of other programming methods that have approximately similar expressive abilities. However, the programs are typically inaccessible by externals systems. Even if the programs were accessible, the programs do not contain explicit information about what kind of events are normal, so that abnormal events can easily be detected.

Relationship Table

In practice, the relationship table can be built by means of a simple and efficient two-step procedure. Initially, all entries in the relationship table are initialized with the ≮ symbol. During the first step, the database is scanned sequentially, and for any pair of events where one event immediately follows another event, the corresponding entry of the relationship table is changed to the > symbol. After the first step, any two events can be either in the > or the ≮ relations. During the second step, the derived relations →, ←, ∥, and # are computed on the basis of the relations > and ≮ discovered during the first step, using the following rules:

A→B if A>B and B≮A;

A←B if A≮B and B>A;

A∥B if A>B and B>A; and

A#B if A≮B and B≮A.

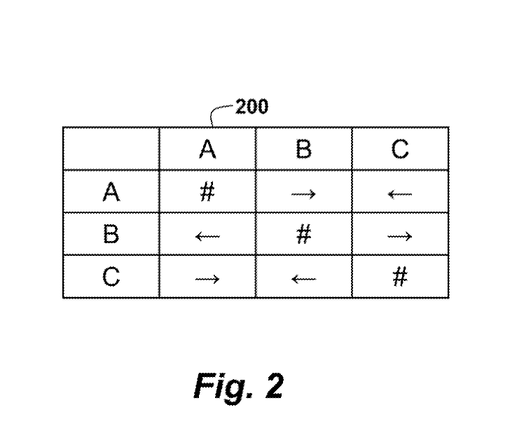

FIG. 2 shows an example log-based ordering relationship table 200, it is noted that the anomaly detection is based on the relationship table, and not a complex complete mined model as in the prior art. The relationship table is not a model. Instead, the relationship table represents summary statistics of the data logs about the discovered positional relationships between pairs of events during normal operation of the DMP as represented by a log-based ordering relationship table.

Task Duration

The task duration is a difference between the time of the current task and the latest time among the events corresponding to all predecessor tasks of the current task in the event trace.

For example, if the event trace contains events (t₁, Op2), (t₂, Op1), (t₃, Op3), with t₁<t₂<t₃, then the duration of task Op3 is d(Op3)=t₃-t₂, because Op1 and Op2 are both predecessors of Op3 in the SWN and Op1 occurred later at time t₂, thus enabling the task Op3 at that time, with the corresponding event: emitted t₃-t₂ time later.

Note that the event corresponding to a given task can be emitted at the beginning, end, middle, or a random time during the task. When the event is always emitted at the end of each task, the collected task durations d actually represents the execution times of the respective tasks. In any of the other cases, the task duration only includes the time until the corresponding event is emitted, but may also include the time between one or more predecessor tasks emitted their events and actually were completed. Regardless of which case is present in a DMP, the task durations are an important property of the process and can be included in its model for the purposes of anomaly detection.

There are several ways in which task durations can be included in the model. One way is to determine the minimal dₘᵢₙ(T) and maximal dₘₐₓ(T) durations for the tasks, and record the durations with the task descriptor. Another way is to assume a specific parametric form for the probability distribution f_{T}(d) over the possible durations d of task T, such as a Gaussian, Beta, or Weibull distribution, and determine the corresponding parameters for that distribution, e.g., for example, mean and standard deviation for the Gaussian distribution.

Real-Time Anomaly Detection

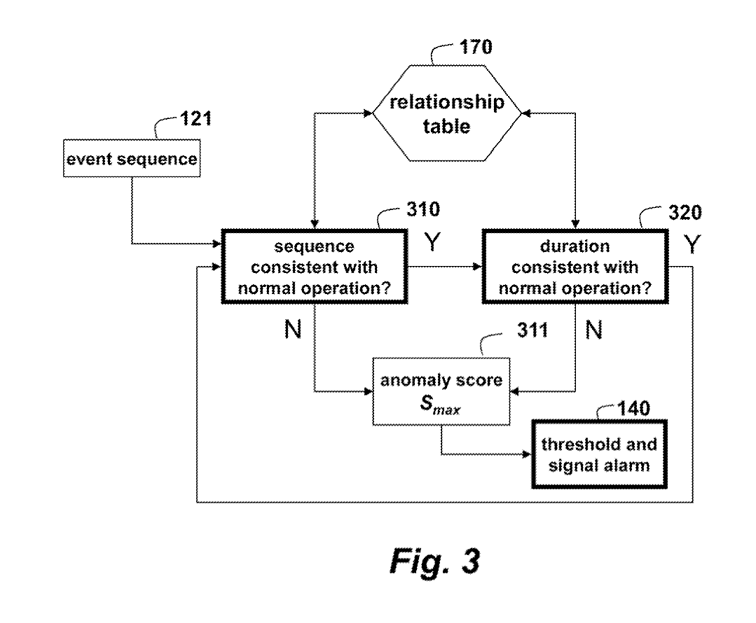

As shown in FIG. 3, the method detects anomalies from the event sequences by determining consistency between the sequence and the model.

The real-time processing has two stages:
determining 310 whether the sequence of events 121 are consistent with normal operation as represented by the model; and
determining 320 whether the task durations are consistent with the table.

It can be determined whether the sequence of events is consistent with the model, and if the sequence is inconsistent, a maximal anomaly score Sₘₐₓ311 can be assigned to the sequence.

Another method for verifying the correctness of the sequence of tasks is to compare the relative order of tasks, as they are observed in the event stream, with the entries of the log-based ordering relation table 170 constructed during the training phase. For example, if the sequence of events AB is observed, but the relation A≮B is present in the relation table, an anomaly can be signaled. Recall that A≮B signifies that A was never followed by B in the training database; if such behavior is observed currently, it is dearly inconsistent with the training data

Although the invention has been described by way of examples of preferred embodiments, it is to be understood that various other adaptations and modifications can be made within the spirit and scope of the invention. Therefore, it is the object of the appended claims to cover all such variations and modifications as come within the true spirit and scope of the invention.

We claim:

1. A method for detecting an anomaly in a discrete manufacturing process (DMP) performing tasks, comprising:
acquiring signals from the DMP;
extracting of events from the signals as a sequence;
determining whether the sequence is inconsistent with a normal behavior as represented by a log-based ordering relationship table and probability distributions over task durations; and
signaling an alarm when the sequence is inconsistent with the normal behavior, wherein the steps are performed in a processor device.

2. The method of claim 1, wherein the log-based ordering relationship table and and probability distributions over task durations are constructed from training signals during a training phase.

3. The method of claim 1, wherein the DMP includes multiple sub-processes that are performed in parallel.

4. The method of claim 3, wherein, all or some of the sub-processes are independent.

5. The method of claim 3, wherein, all or some of the sub-processes are coordinated.

6. The method of claim 2, wherein the training signals are acquired from program logic controllers (PLC) during normal operation of the DMP.

7. The method of claim 1, further comprising:
determining an anomaly score for the sequence; and
determining the sequence as inconsistent if the anomaly score exceeds a predetermined threshold.

8. The method of claim 1, wherein the events correspond to changes in levels of the signals.

9. The method of claim 1, further comprising:
determining minimal and maximal durations for the tasks.

10. The method of claim 1, further comprising:
determining whether task durations of the tasks are inconsistent with the model.
